(19) United States
(12) Patent Application Publication
(10) Pub. No.: US 2015/0043872 A1
(43) Pub. Date: Feb. 12, 2015

(54) FERRULE WITH PROTRUDING FIBERS

(71) Applicant: Tyco Electronics Corporation, Berwyn, PA (US)

(72) Inventors: Michael Aaron Kadar-Kallen, Harrisburg, PA (US); Michael Lawrence Gurreri, York, PA (US)

(21) Appl. No.: 14/336,309

(22) Filed: Jul. 21, 2014

Related U.S. Application Data
(63) Continuation of application No. 12/872,391, filed on Aug. 31, 2010, now abandoned.

(51) Int. Cl. G02B 6/40

(52) U.S. Cl. CPC G02B 6/40
USPC 385/78

(57) ABSTRACT

A ferrule assembly comprising: (a) a ferrule body defining a plurality of bores and having an end face having an inner portion and outer portions on opposite sides of said first portion; (b) a plurality fibers disposed in said bores and protruding beyond said end face; and (c) a protruding element on each outer portion, said protruding element having a first or second configuration, in said first configuration, said protruding element comprises a portion of said outer portion that protrudes beyond said inner portion but not as far as said fibers protrude, and in said second configuration, said protruding element comprises at least one fiber in a bore in said outer portion that protrudes beyond any fiber in a bore in said inner portion.

### FIELD OF INVENTION

The present invention relates generally to a multi-fiber ferrule, and, more particularly, to a multi-fiber ferrule configured to reduce mating force.

### BACKGROUND

To mate multi-fiber connectors, the end portions of the plurality of optical fibers contained in one ferrule must generally be brought into physical contact with the end portions of corresponding optical fibers contained in a mating ferrule. Typically, such ferrules have cooperating alignment pins/holes to align the ferrule end faces such that the fiber ends align and thus make physical contact. If multi-fiber connectors are mated without establishing direct physical contact between the corresponding optical fibers, the signals propagating along the optical fibers may be significantly attenuated, and the reflectivity experienced by the signals may be greatly increased.

Conventional wisdom holds that, to facilitate direct physical contact between the ends portions of corresponding optical fibers, the end portions of the optical fibers should extend beyond the end face of the ferrule defining a protrusion distance. This way, the optical fibers will generally extend beyond any imperfections in the end face of the ferrule and beyond dust, dirt or the other debris that may collect upon the end face of the ferrule.

Conventional wisdom also holds that, to establish physical contact between corresponding optical fibers of a pair of mated multi-fiber connectors, the end portions of the optical fibers must not only protrude beyond the end face of the respective ferrule, but must also be relatively co-planar, i.e., the end portions of the optical fibers of each respective mating part must generally lie within the same plane. (See, for example, U.S. Pat. No. 6,957,920 observes that “as the variance in protrusion of the fibers increases, the difficulty in establishing direct physical contact between the end portions of each corresponding pair of optical fibers also increases.”)

Although high protrusion and co-planarity have been embraced as enhancing physical contact, Applicants have discovered unexpectedly that such features also tend to increase the required mating force between ferrules, especially in the event of angular misalignment between the ferrules. As used herein, “angular misalignment” refers to the angle that the perpendicular of the ferrule end face differs from the axis of the alignment hole in the ferrule. As a practical matter, Applicants have observed mechanically transferable (MT) type ferrules typically have a certain amount of angular misalignment, typically introduced during polishing because the ferrules are not held in place by the alignment holes, but rather by other features on the outside of the ferrule which may not be precisely aligned with the alignment holes. Therefore, Applicants have identified a need to enhance physical contact between fibers while decreasing the mating force between the ferrules having angular misalignment. The present invention fulfills this need among others.

### SUMMARY OF INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention provides for a ferrule having protruding elements on opposing sides of its end face relative to the interior of the end face to reduce the required mating force between angular misaligned ferrules. By way of background, Applicants discovered unexpectedly that, although ferrule assemblies with good coplanarity mate with relative little force when there is no angular misalignment between them, significant force is required when the ferrules are angularly misaligned. This is because, when the ferrules are angularly misaligned, mating all the fibers requires bending the guide pins slightly. The pins are stiff, however, and thus resist this bending.

Without being bound to any particular theory, applicants theorized that the protruding elements of the present invention reduce the mating force between angularly misaligned ferrules because, when the protruding elements contact, they function as fulcrums, forming a “lever arm” in the ferrule between the protruding element and the applied mating force (which is generally assumed to be essentially in the center of the ferrule). Because the protruding element is disposed at or near an edge of the ferrule, this lever arm is maximized. As is known in mechanics, a longer lever arm will develop greater torque for a given force. Consequently, less mating force is required to close the angular gap between two fibers using the protruding elements as fulcrums in the present invention. Thus, ferrules of the present invention tend to require less mating force for a range of ferrule angular misalignment than traditional ferrule assemblies with high coplanarity.

The present invention not only exploits the lever arm effect as mentioned above, but still realizes the benefits of high fiber protrusion. That is, in one embodiment, the fibers still protrude from the ferrule end face thus facilitating physical contact. Thus, the invention combines the advantages of fiber protrusion with an extended lever arm to create an improved ferrule design that takes the best features from each approach.

Accordingly, one aspect of the invention is a ferrule assembly having a protruding element at or near an edge of its end face to function as a fulcrum, and thereby provide mechanical advantage in mating angularly misaligned ferrules. In one embodiment, the ferrule assembly comprises: (a) a ferrule body defining a plurality of bores and having an end face having an inner portion and outer portions on opposite sides of the first portion; (b) a plurality fibers disposed in the bores and protruding beyond the end face; and (c) a protruding element on each outer portion, the protruding element having a first or second configuration, in the first configuration, the protruding element comprises a portion of the outer portion that protrudes beyond the inner portion, but not as far as the fibers protrude, and, in the second configuration, the protruding element comprises at least one fiber in a bore in the outer portion that protrudes beyond any fiber in a bore in the inner portion.

### BRIEF SUMMARY OF DRAWINGS

FIG. 1 is a perspective schematic view of one embodiment of the first configuration of the present invention in which the end protruding elements are part of the ferrule end face.

FIG. 2 is a side view of the embodiment of FIG. 1.

FIG. 3A illustrates the mating of two ferrules having protruding fibers when end faces of the ferrules are misaligned;

FIG. 3B illustrates the two ferrules of FIG. 3A when all fibers have made physical contact;

FIG. 4A illustrates the mating of two ferrules having fibers protruding a greater distance than the fibers of FIG. 3A;

FIG. 4B illustrates the two ferrules of FIG. 4A when all fibers have made physical contact;

FIG. 5 shows a schematic of another embodiment of the first configuration of the present invention in which the entire edge of the ferrule protrudes with respect to the central portion where the fibers are located.

FIG. 6 shows a side view of yet another embodiment of the first configuration in the end protruding elements are non-planar.

FIG. 7A illustrates the mating of two aligned ferrules having protruding fibers that form an inverted V;

FIG. 7B illustrates the two ferrules of FIG. 7A when the ferrules are mated;

FIG. 7C illustrates the mating of two misaligned ferrules having protruding fibers that form an inverted V;

FIG. 7D illustrates the two ferrules of FIG. 7C when the ferrules are mated;

FIG. 8A illustrates the mating of two aligned ferrules having protruding fibers that form a V;

FIG. 8B illustrates the two ferrules of FIG. 8A when the ferrules are mated;

FIG. 8C illustrates the mating of two misaligned ferrules having protruding fibers that form a V;

FIG. 8D illustrates the two ferrules of FIG. 8C when the ferrules are mated;

FIG. 9A illustrates the mating of two aligned ferrules having protruding fibers that are coplanar;

FIG. 9B illustrates the two ferrules of FIG. 9A when the ferrules are mated;

FIG. 9C illustrates the mating of two misaligned ferrules having protruding fibers that are coplanar;

FIG. 9D illustrates the two ferrules of FIG. 9C when the ferrules are mated;

FIG. 10 is a perspective schematic view of one embodiment of the second configuration of the present invention in which the end protruding elements are fibers.

FIG. 11 is a perspective schematic view of another embodiment of the second configuration of the present invention in which the end protruding elements are fibers along the x and y axes.

### DETAILED DESCRIPTION

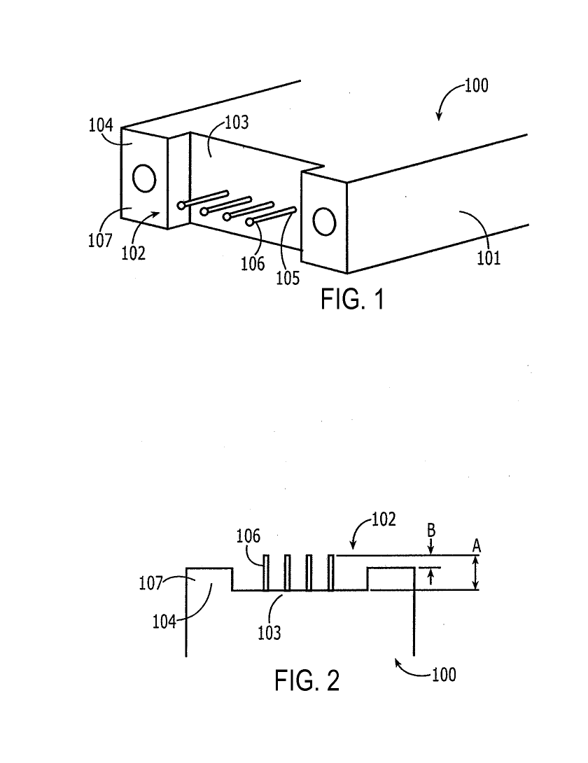

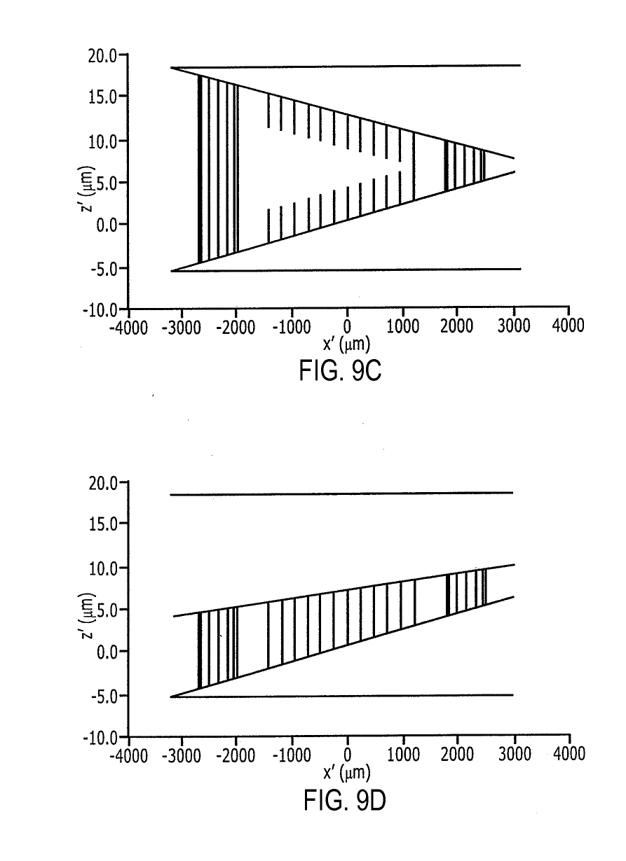

Referring to FIGS. 1 and 10, embodiments of the ferrule 100, 1000 of the present invention are shown. Ferrule assembly 100, 1000 comprises a ferrule body 101, 1001 having an end face 102, 1002 and defining a plurality of bores 105, 1005. The end face 102, 1002 has an inner portion 103, 1003 and outer portions 104, 1004 on opposite sides of the inner portion 103, 1003. The bores 105, 1005 hold a plurality fibers 106, 1006, each of which protrudes beyond the end face 102, 1002. On the outer portions 104, 1004 are protruding elements 107, 1007 configured in one of two ways. In the first configuration, shown in FIG. 1, the protruding element 107 is a portion of an outer portion 104 that protrudes beyond the inner portion 103. In the second configuration, shown in FIG. 10, the protruding element 1007 comprises one or more outer fibers 1006a of the plurality of fibers 1006 that are disposed in bores 1005 in the outer portions 1004 and protrude beyond inner fibers 1006b disposed in bores in the inner portion 1003.

In either configuration, the protruding elements function as fulcrums, creating a lever action across the width of the ferrule end face to overcome angular misalignment between mating ferrules. Thus, ferrules of the present invention tend to require less mating force for a range of connector angular misalignment than traditional ferrule assemblies with high coplanarity.

Various, non-limiting embodiments of the present invention are described in detail below. For illustrative purposes, the embodiments disclosed relate to MT-type multi-fiber ferrules, which are common in the industry. Typically, although not necessarily, an MT-type ferrule comprises a rectangular end face having two opposing short sides and two opposing long sides. The number of fibers contained in the ferrule can vary, although common MT-type ferrules contain one to six rows of fibers with two to twelve fibers in a row. It should be understood however that the invention is not limited to any particular number of fibers. Also, an MT-type ferrule typically comprises alignment means which usually comprise alignment holes at the ends of the ferrule end face, adapted to receive alignment pins to align one MT-type ferrule having alignment holes with another MT-type ferrule having the same configuration of alignment holes. Such configurations are well known in the art and require no additional description herein. Although MT-type ferrules are considered herein in detail, this is only for illustrative purposes and the claims should not be limited to such an embodiment unless expressly stated. Furthermore, although a rectangular end face of the ferrule is most common, the invention is not necessarily limited to such.

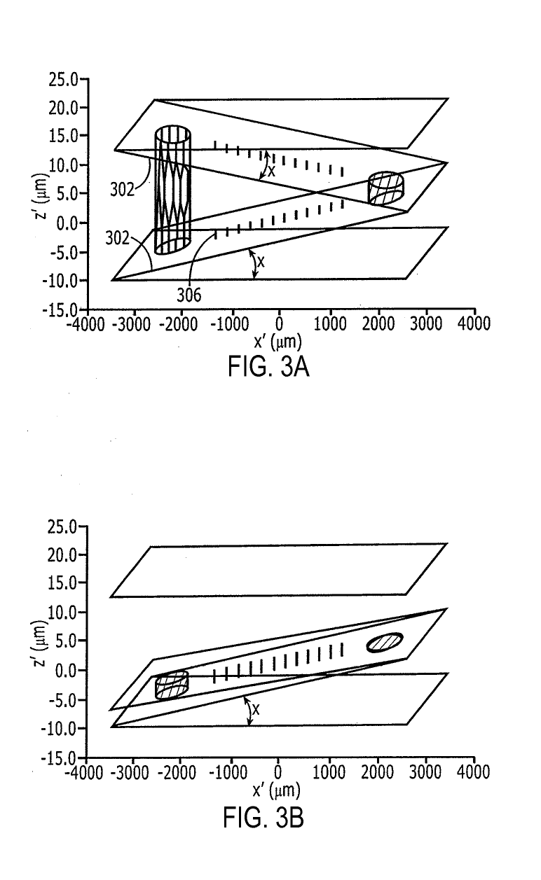

Considering initially the first configuration, various embodiments are shown in FIGS. 1, 2, 5, and 6. Specifically, in FIGS. 1 and 2, the end face 102 of a ferrule 100 is shown in which the fibers 106 protrude from the inner portion 103 of the end face 102 of the ferrule by at least a distance A (see FIG. 2), but protrude beyond the protruding elements 107 in the outer portion 104 of the end face by at least a distance B, wherein distance B is less than distance A. In one embodiment, distance A is greater than 1 μm, more particularly between about 2 and about 200 μm, and still more particularly between about 3.5 and about 10 μm. Distance B is less than A but large enough to ensure that the protruding members of mating ferrules meet with moderate angular misalignment (e.g. 0.1-0.5°). Accordingly, in one embodiment, B is at least 1 μm, more particularly between about 1 and about 5 μm, and still more particularly between about 1.0 and about 3.5 μm. It should be understood, however, that the present invention should not be limited to particular fiber protrusion limitations unless specifically indicated.

The ferrule 100 has the beneficial feature of protruding fibers to enhance physical contact and protruding elements to reduce mating force when encouraging angular misalignment of between ferrule assemblies. The advantage of having the fibers protrude from inner portion 103 is that the fibers will contact before any irregularities that may exist on the surface of the ferrule become obstructive. Such irregularities include the following:
Intrinsic roughness of the ferrule, which is typically constructed of a plastic such as polyphenylene sulfide (PPS) filled with small glass particles. The glass particles may be irregularly shaped, or may be spherical.
Unwanted features imprinted on the ferrule as a result of the molding process.
Dust or debris from the environment, including debris that is generated by continual mating of the metal guide pins into the plastic ferrule.

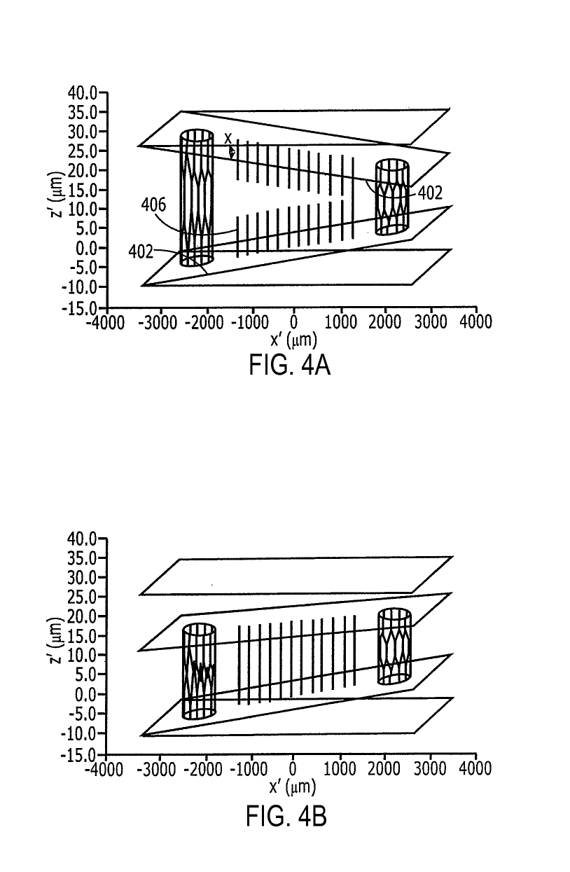

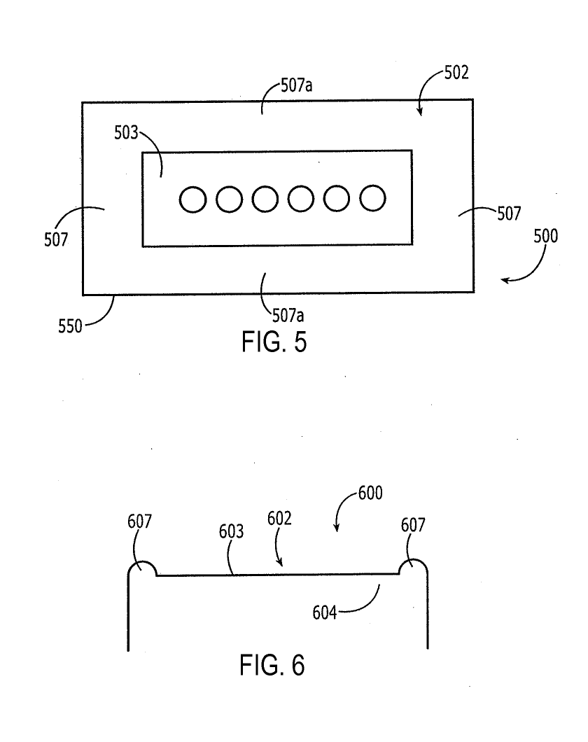

The advantage of the protruding elements is not as obvious. It is often assumed that, when two MT ferrules mate, it is preferable that the ferrules do not touch. However, Applicants have discovered surprisingly that the mating force is actually reduced if the ferrules touch. More specifically, referring to FIGS. 3 and 4, two cases are considered. In both cases, the fibers are perfectly coplanar, with each fiber protruding an equal amount from a perfectly planar ferrule end face. Also, the initial angular misalignment is 0.1 degrees. It should be understood that this particular angular misalignment is along the x-axis and thus is referred to as the “x-angle.” Such an angle is of singular importance when there is only one row of fibers as shown. However, the angular misalignment along the y-axis also becomes significant as the number of rows increases. For example, in a common 72-fiber ferrule, which has 6 rows of 12 fibers, the y-angle is controlled by a lever arm that is 5/11 the lever arm that controls the x-angle, which is not insignificant. Therefore, it should be understood that the principles discussed here with respect to the x-angle also apply to the y-angle in ferrules having multiple rows of fibers.

As mentioned above, there is generally some angular misalignment between the end face of the ferrule and the alignment holes. When two ferrules are mated, the misalignment between the ferrules will be the sum of these two x-angles. It should be apparent that in some orientations, the summation of the x-angles will tend to cancel each other out, and minimize angular misalignment, and in other orientations, the x-angles will tend to compound and increase the angular misalignment between the ferrules. Of particular interest herein, is the compounding of the misalignment, as such a condition poses the most difficult challenge in mating. Accordingly, in FIGS. 3(a) & (b) and 4(a) & (b) the x-angle is compounded between ferrules.

In the first case, shown in FIG. 3(a), the fibers 306 each protrude 1 μm and the ferrule end faces 302 make contact first. (It should be understood that the fiber protrusion depicted in FIGS. 3-9 is greatly exaggerated to illustrate the concepts of the present invention. Also, the scale between the various figures is not necessarily the same.) The mating force required for all the fibers to make physical contact as shown in FIG. 3(b) is 7.1 N. On the other hand, in second case, the fibers 406 protrude 10 μm from the end face 402 of each ferrule as shown in FIG. 4(a). Here, the mating force required to mate the end faces 402 as shown in FIG. 4(b) is 18.7 N, more than double the force in first case. As mentioned above, this difference in mating force can be attributed to the lever arm effect when the ferrules touch. Specifically, when the surfaces of a ferrule are at an angle with respect to the guide pins—i.e., when there is angular misalignment as is typically the case, the mating of two fibers requires the guide pins to bend. The pins are stiff, however, and thus resist this bending. When the ferrules touch on an edge, a “lever arm” is formed between the contacting edges and the applied force in the ferrule, which is generally assumed to be in the center of the ferrule. This lever arm is larger than any formed if just the fibers touch—i.e., the distance between the fibers and applied force is necessarily less than the distance between the edge of the ferrule and applied force. This mechanical advantage therefore increases the torque for a given force, and thus causes the pins to bend with less force. Less mating force is therefore required to close the angular gap between two ferrules if the ferrules touch.

In the first configuration, contact along the edges of mating ferrules is essentially assured by using protruding elements on the outer portions as described above. Generally, it is desirable to make the lever arm as long as possible by configuring the fulcrum as far to the edge of the ferrule end face as possible. Accordingly, in one embodiment, the protruding elements 107, which function as the fulcrum in the lever arm, are essentially contiguous with opposing sides of the ferrule. Furthermore, to maximize the lever arm between the fulcrum and the applied force, at least one the lever arm should run along the long length of the ferrule end face if the ferrule end face is elongated. Accordingly, in one embodiment, the protruding elements are located on the short sides of the ferrule end face, thereby allowing the lever arm to run along the elongated dimension of the ferrule.

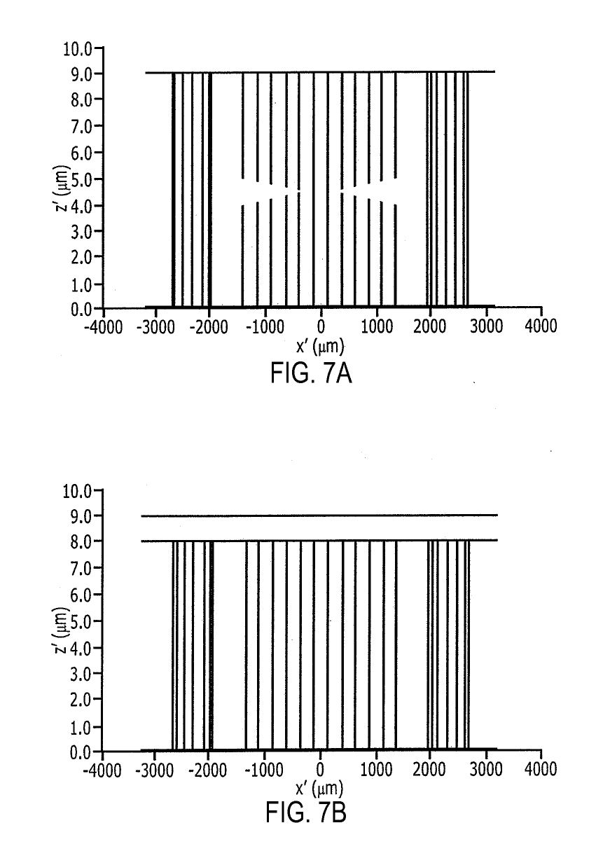

Referring to FIG. 5, an alternative embodiment of the ferrule 500 of the present invention is shown. In this embodiment, the second protruding elements 507a are added to the opposing long sides of the ferrule end face 502. In this particular embodiment, the protruding elements 507 and 507a form a contiguous ring around the perimeter 550 of the end face 502, thereby encircling the inner portion 503. Such a configuration is well suited for a ferrule configuration involving multiple rows in which a lever arm is established not only along the x-axis (i.e., along the rows), but also along the y-axis (i.e., across the rows). Specifically, this provides mechanical advantage for mating ferrules having both x-angle misalignment and y-angle misalignment. (It should be understood that, while the embodiment of FIG. 5 is well suited for establishing a lever arm along the y-axis to counteract y-axis misalignment, the embodiment in FIG. 1 also facilitates a lever arm in this direction. Specifically, in the embodiment of FIG. 1, the fulcrum for both the x and y-axis lever arms is provided by the protruding elements 107, which project from all four corners. Although the embodiment of FIG. 5 contains additional material along the long side of the ferrule (i.e., second protruding element 507a), this will not necessarily facilitate the y-axis lever arm more effectively because, to obtain the longest lever arm, it is only necessary that some portion of the edges of the ferrule protrude. Nevertheless, having the second protruding element 507a likely enhances the robustness of the ferrule and may provide additional stability during the mating process.) Again, such a configuration is contrary to traditional ferrule end face configuration in which the end face was either flat or domed with the apex of the dome at essentially the center of the end face.

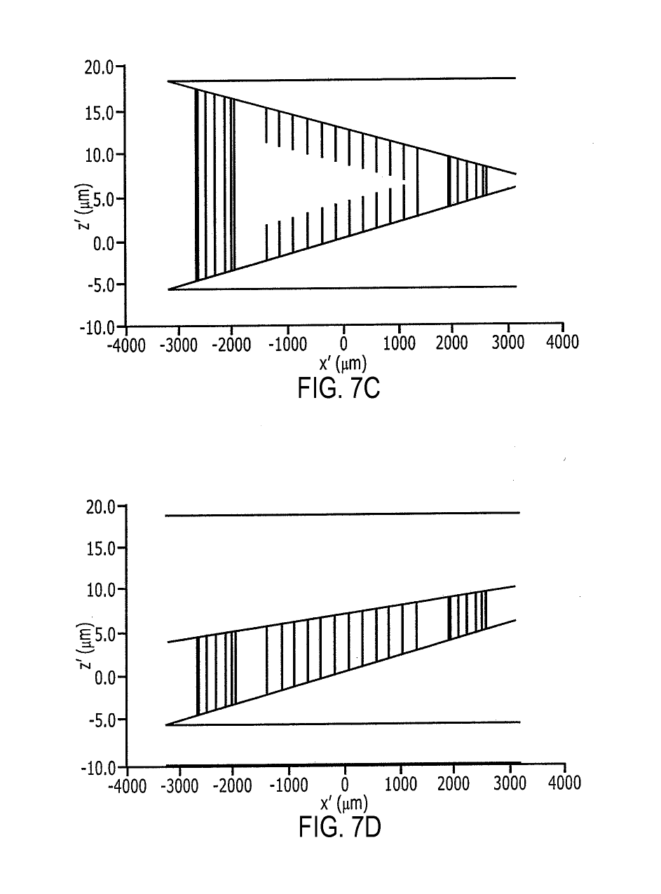

Yet another embodiment of the ferrule 600 (fibers not shown) of the first configuration is shown in FIG. 6. In this embodiment, the protruding elements 607 in the outer portion 604 of the end face 602 are non-planar, and profiled. In the embodiment shown in FIG. 6, the profile is rounded. In one embodiment, these features are constructed to be small (for example 200 μm wide), such that if protruding elements 607 of mating ferrules touch, then they will be compressed and will not interfere with the protruding fibers located in the inner portion 603, even if such fibers are slightly recessed compared to the raised, undeformed protruding elements 607. Although rounded protruding elements 607 are shown, it should be understood that they may be spherical or cylindrical, or any other shape, including shapes that would appear to be planar when viewed from the perspective of FIG. 6, such as a cylinder oriented along the x-axis of the ferrule.

Considering the second configuration, the protruding elements 1007 comprise exterior fibers that protrude further than the interior fibers. It is generally assumed that perfect coplanarity, where the tips of all fibers lie in a plane, is the preferred embodiment. It is true that if the surfaces of the mating ferrules are parallel when the guide pins are undeflected, then the mating force is zero if both surfaces are perfectly coplanar (or are otherwise complementary). However, as mentioned above, in a real manufacturing environment, there is a small angle between the guide pin bore and the end face of the ferrule.

To compensate for this, the fibers are arranged in the second configuration to protrude further at the outer portion 1004 of the ferrule end face 1002. This can be accomplished using a variety of different fiber protrusion profiles. More specifically, as is typical in MT-type ferrules, the fibers run in one or more rows parallel to the long sides of the ferrule end face. In one embodiment, the protrusion of the fibers increases from the center of the row outward. The increase may be gradual with each sequential fiber, or it may be in steps with groups of fibers. In particular, the fibers may protrude (either sequentially or in steps) to define an upward V-shape or concave profile. Examples of concave profiles include radiused, non-radiused, parabolic, and compound curves. In a simple embodiment, just the fibers on the outside of the rows protrude and function as protruding elements.

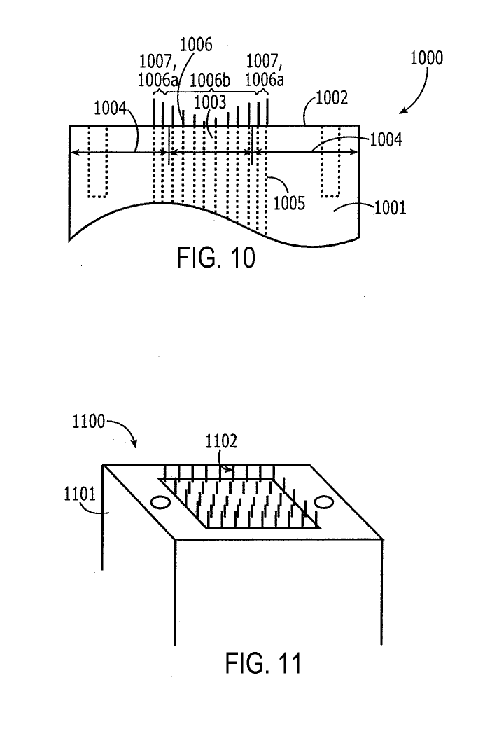

In an embodiment of a ferrule having three or more rows, the upward V-shape or concave profile may be defined not only along a row (x axis), but also across rows (y axis). In other words, the protrusion of the fibers increases from the center row(s) to the outer rows. Such a profile is desirable to provide a y-axis lever arm to compensate for y-axis misalignment. Like the profile along the rows, the profile across the rows may be gradual, or it may be in steps with groups of fibers. In particular, the fibers may protrude to define an upward V-shape or concave profile along the y axis. It should be understood that the combination of the fiber protrusion profiles along the x and y axes can form a number of three-dimensional surface contours including varying ellipsoid forms, inverted pyramids, inverted cones, cylinders, etc. (See, for example, application Ser. No. 12/872,315, incorporated herein by reference.) For example, in FIG. 11, a ferrule assembly 1100 is shown in which the ferrule 1101 has 5 rows of 9 fibers which protrude to form an ellipsoid 1102 profile with their end faces (again the fiber protrusion is greatly exaggerated in this illustration). The greatest protrusion is along the outer fibers, thus enabling the fibers to act as fulcrums in both the x and y axes as described above.

The configuration of the present invention has a number of advantages. For example, like the protruding elements of the first configuration, the outer fibers may act as fulcrum. If the outer fibers touch first, then the torque will be higher than if the inner fibers touch first. Another advantage is that, when the fibers have a concave or V-shape profile, one side of the V will contact first. The contacting side of the V compresses as the mating ferrules rotate. The other side of the V will come into contact sooner than if the V were inverted (as is typically the case) or than if the fibers were coplanar. It is important that the V not be too deep, or a high force will be required to bring the inner fibers into contact. Traditionally having the outer fiber make and maintain physical contact has been a challenge.

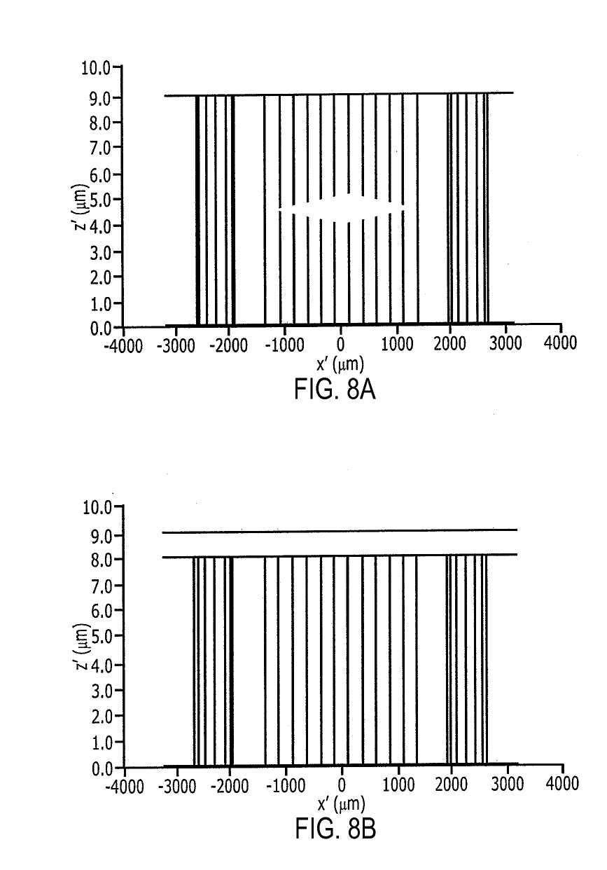

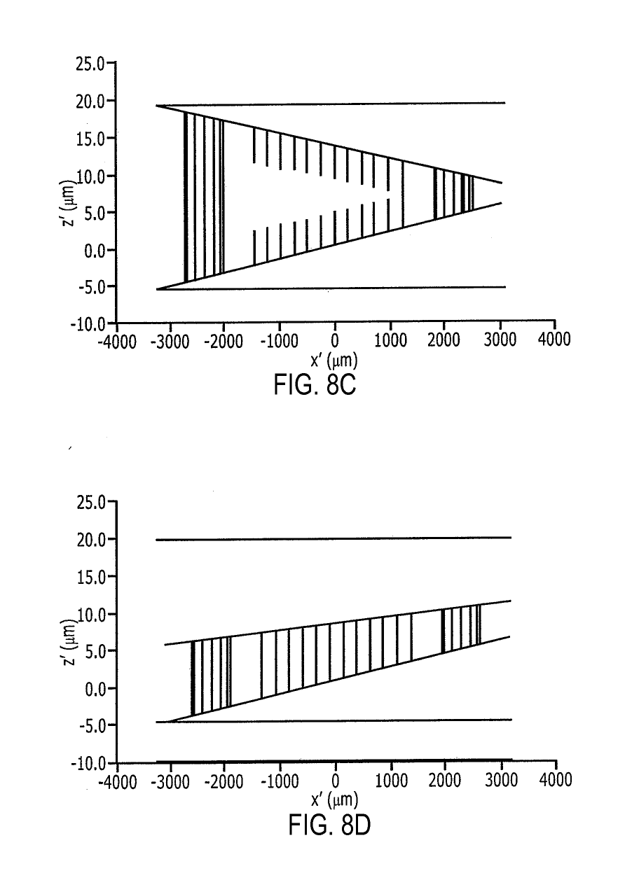

Referring to FIGS. 7-9 and Table 1 below, the mating force for three different fiber profiles at different angular alignments are shown. In these particular examples, a single row, twelve (12) fiber ferrule is used. In Example A (FIG. 7), the fibers protrude to define an inverted V, with the protrusion varying linearly from 4 μm on fiber 1 to 4.5 μm on fiber 5 and 6; to 4 μm on fiber 12. In Example B (FIG. 8), the fibers are distributed as a V, with the protrusion varying linearly from 4.5 μm on fiber 1, to 4.0 μm on fiber 5 and 6, to 4.5 μm on fiber 12. In Example C (FIG. 8), the fibers have the same protrusion (4 μm), and are perfectly coplanar.

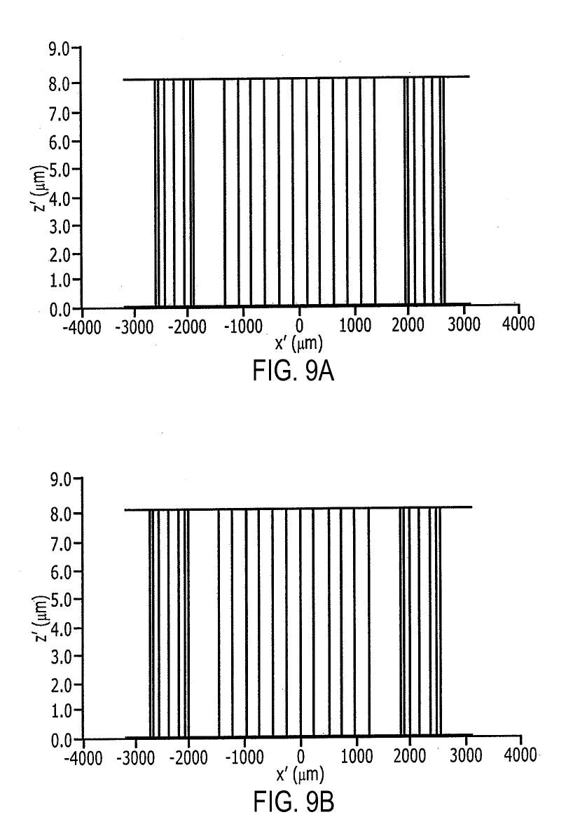

FIGS. 7(a) and (b) illustrate the ferrules of Example A in a pre-mating and mated state, respectively, in which the x-angle is 0. FIGS. 7(c) and (d) illustrate the ferrules of Example A in a pre-mated and mated state, respectively, in which the x-angle is 0.1 degrees. FIGS. 8(a) and (b) illustrate the ferrules of Example B in a pre-mated and mated state, respectively, in which the x-angle is 0 degrees. FIGS. 8(c) and (d) illustrate the ferrules of Example B in a pre-mated and mated state, respectively, in which the x-angle is 0.1 degrees. FIGS. 9(a) and (b) illustrate the ferrules of Example C in a pre-mated and mated state, respectively, in which the x-angle is 0 degrees. And finally, FIGS. 9(c) and (d) illustrate the ferrules of Example C in a pre-mated and mated state, respectively, in which the x-angle is 0.1 degrees.

The results are as shown in Table 1. In manufacturing ferrules, the x-angle will span a range of angles. In order to guarantee contact in all situations, the goal is to minimize the worst-case mating force. The preferred embodiment in this example is therefore configuration B. Note that configurations A and C both exceed the nominal 10 N mating force of a standard MPO connector, and so are unacceptable when the x-angle is 0.1 degrees. Finally, note that the preferred embodiment, with the outer fibers protruding more than the inner fibers, is the opposite of what is achieved with standard polishing processes.

TABLE 1

| Configuration | Force (N) x-angle 0° | Force (N) x-angle 0.1° |
|---|---|---|
| A (inverted “V”) | 3.4 | 16.8 |
| B (“V”) | 3.7 | 7.7 |
| C (coplanar) | 0 | 11.7 |

Although good results have been shown with an inverted V shape described above, it should be understood that other profiles in which the outer fibers protrude further than the inner fibers is within the scope of the invention. For example, the profile may resemble a concave curve (the curve may be radiused, non-radiused, or parabolic), an inverted bell curve, or a stepped V or U (e.g. two or more adjacent fiber may protrude the same). In one embodiment, only the end fibers protrude from the other fibers. In another embodiment, the coplanarity of the fiber end faces is greater than 100 nm, with the greatest variation occurring between the inner fibers and the outer fibers. In yet another embodiment, the fiber profile may be described by an even polynomial function of x and y, in which the profile will be symmetric about the center of the ferrule. If the angular tolerances are not symmetric or in the case of a ferrule which has an end face which is not perpendicular to the guide pin axis by design (e.g., an 8 degree end face on a single mode ferrule), it may be advantageous to have a non-symmetric end face profile. This may lead to a desired fiber profile that is expressed as a polynomial with both even and odd terms (with the fiber profile being measured with respect to the angled end face). It should also be understood that the profiles discussed herein may apply not only along the rows (x-axis), but also across the columns (y-axis) in the case of a multi-row ferrule.

There are several methods for achieving the desired profile of the fiber end protrusion. For example, laser cleaving may be used in which a laser scanned with respect to a ferrule can cut the fibers such that the protruding elements of the fibers follow a predetermined pattern. Alternatively, the laser may be stationary, with the beam shaped such that the fibers are cut to follow the predetermined pattern (see e.g., U.S. Pat. No. 6,246,026, incorporated by reference). In yet another embodiment, the fibers may be cleaved and then pushed back into position as disclosed in U.S. Pat. No. 7,377,700 and application Ser. No. 12/872,315, both of which are incorporated herein by reference. In this respect, the fixture that pushes the fibers can be shaped to affect the desired distribution of protruding elements. The fixture may contain raised features which hold the fixture away from a flat ferrule at a pre-determined distance. In still another embodiment, the fiber profile may be achieved using a pre-shaped ferrule, in which the standard polishing processes are affected to some extent by the shape of the unpolished ferrule. For example, an unpolished ferrule with a concave surface may result in a polished surface that is concave, with the outer fibers protruding more than the inner fibers. (This will depend on the specific polishing process. Interestingly, current polishing processes have been developed to minimize this type of effect.) Still another embodiment involves using a non-uniform ferrule shape. Specifically, if the middle of the ferrule is not as wide as the ends, then it is expected that the middle section will polish more rapidly, and hence the middle fibers will be recessed with respect to the outer fibers. Another embodiment uses a non-uniform ferrule material. For example, the middle of the ferrule may be less dense compared to the material on the outside edges of the ferrule such that the middle of the ferrule is polished away more quickly than the edges of the ferrule. Conversely, rigid materials (e.g., metal rods) may be added to the edges of the ferrule, causing the edges of the ferrule to polish more slowly than the center of the ferrule. Alternatively, the rods may be glass, or may in fact be additional “sacrificial” fibers which are added to reduce the rate at which the outer fibers are polished away. Alternatively, the middle of the ferrule may have regions in which material has been removed in some places such that the remaining regions of the middle of the ferrule are polished away more quickly than the edges of the ferrule. Still other method and approaches will be obvious to one of skill in the art in light of this disclosure.

While the present invention has been particularly shown and described with reference to the preferred mode as illustrated in the drawing, it will be understood by one skilled in the art that various changes in detail may be effected therein without departing from the spirit and scope of the invention as defined by the claims.

1-20. (canceled)

21. A ferrule assembly comprising:
a ferrule body defining a plurality of bores and having an end face having an inner portion and outer portions on opposite sides of said inner portion;
a plurality fibers disposed in said bores and protruding beyond said end face, the plurality of fibers arranged in at least one row, the plurality of fibers including exterior fibers disposed at opposite ends of the at least one row and interior fibers disposed between the exterior fibers, the exterior fibers protruding further than the interior fibers.

22. The ferrule assembly of claim 21, wherein the plurality of fibers define an upward V-shaped profile along the at least one row.

23. The ferrule assembly of claim 21, wherein the plurality of fibers define a concave profile along the at least one row.

24. The ferrule assembly of claim 21, wherein the exterior fibers step up from the interior fibers.

25. The ferrule assembly of claim 21, wherein the exterior fibers gradually increase in height relative to innermost fibers.

26. The ferrule assembly of claim 21, wherein the at least one row has only two exterior fibers; wherein any other fiber in the row is an interior fiber.

27. The ferrule assembly of claim 21, wherein outermost fibers of the at least one row protrude about 0.5 μm further than an innermost fiber of the at least one row.

28. The ferrule assembly of claim 27, wherein the innermost fiber protrudes about 4 μm from the end face.

29. The ferrule assembly of claim 21, wherein the plurality of fibers are disposed in multiple rows, wherein the exterior fibers are disposed at opposite ends of each row.

30. The ferrule assembly of claim 29, wherein the plurality of fibers define an upward V-shaped profile across the multiple rows.

31. The ferrule assembly of claim 29, wherein the plurality of fibers define a concave profile across the multiple rows.

32. The ferrule assembly of claim 29, wherein the multiple rows include outer rows and at least one inner row, and wherein fibers of the outer rows step up from the fibers of the inner row.

33. The ferrule assembly of claim 29, wherein the multiple rows include outer rows and inner rows, and wherein the fibers of the outer rows gradually increase in height relative to fibers of the inner rows.

34. The ferrule assembly of claim 29, wherein the multiple rows include outer rows and at least one inner row, wherein fibers of the outer rows protrude about 0.5 μm further than the fiber of the inner row.

35. The ferrule assembly of claim 34, wherein the fibers of the inner row protrude about 4 μm from the end face.

36. The ferrule assembly of claim 29, wherein the plurality of fibers define a three-dimensional surface contour including an ellipsoid form.

37. The ferrule assembly of claim 29, wherein the plurality of fibers define a three-dimensional surface contour including an inverted pyramid form.

38. The ferrule assembly of claim 29, wherein the plurality of fibers define a three-dimensional surface contour including an inverted cone form.
